(19) United States
(12) Patent Application Publication
(10) Pub. No.: US 2025/0165875 A1
(43) Pub. Date: May 22, 2025

(54) OPTIMIZATION FOR DETERMINING AVAILABILITIES

(71) Applicant: Amadeus S.A.S., Biot (FR)

(72) Inventors: Pierre FEUILLET, Antibes (FR); Guillaume GENET, Antibes (FR); Victoria BOSQ, Nice (FR); Gabriele ROMANO, Antibes (FR); Andrea PACE, Vallauris (FR)

(21) Appl. No.: 18/673,833

(22) Filed: May 24, 2024

Related U.S. Application Data
(60) Provisional application No. 63/601,788, filed on Nov. 22, 2023.

(51) Int. Cl. G06Q 10/02; G06Q 30/0201

(52) U.S. Cl. CPC G06Q 10/02; G06Q 30/0206

(57) ABSTRACT

Methods, systems, and computer program products for determining availability computation variation data for the provided time frame. An availability request associated with a travel provider is received from a user device. Future travel information associated with the travel provider is obtained, the future travel information includes one or more attributes. Availability computation data for future departure dates is determined via an availability determination algorithm. Availability computation variation data for the provided time frame is determined. An availability user interface is provided to the user device. The availability user interface may include a graphical display of the availability computation variation data for the provided time frame.

### CROSS-REFERENCE TO RELATED APPLICATION

This application claims the benefit of U.S. Provisional Application No. 63/601,788, filed Nov. 22, 2023, which is hereby incorporated by reference herein in its entirety.

### TECHNICAL FIELD

The present disclosure generally relates to computers and computer software, and more specifically, to methods, systems, and computer program products for implementing an optimization of determining availabilities.

### BACKGROUND

The provision of products and services to a customer often involves several systems, each serving a different function. In the travel industry, such as an airline, for example, the provision of products and services may involve a system for tracking the number of seats available on each scheduled flight, a system for managing reservations, a system for managing operations at the airport, and a system for determining availabilities and pricing for future flights. It may be difficult for airlines to have a clear view of availabilities that were proposed at a route/network level and understand what may be driving particular trends that may affect determining available price ranges associated with different groups (e.g., booking classes). Thus, improved methods, systems, and computer program products are needed for optimization of determining travel availabilities, specifically for airlines (e.g., the airline revenue management principle: “Sell the right seats to the right customers at the right prices and the right time”).

### SUMMARY

Embodiments of the present invention provide systems, methods, and computer-readable storage media for implementing a tokenization authentication system. The method, at an electronic device including one or more processors, includes receiving, at an availability determination server, an availability request from a user device associated with a travel provider, obtaining, based on the availability request, future travel information associated with the travel provider, wherein the future travel information includes one or more attributes, determining, via an availability determination algorithm, availability computation data for future departure dates, determining availability computation variation data for a provided time frame, and providing an availability user interface to the user device, the availability user interface including a graphical display of the availability computation variation data for the provided time frame.

In some embodiments of the invention, the one or more attributes include origin and destination information, departure dates, price levels through availability for current and past shopping dates, or a combination thereof.

In some embodiments of the invention, the future travel information includes class information proposed to a user and yield information associated for a particular timeframe.

In some embodiments of the invention, determining the availability computation data for the future departure dates includes determining a lowest class available (LCA) average, a weight associated with the LCA, dynamic pricing, intervention input, potential revenue data, or a combination thereof.

In some embodiments of the invention, the availability computation data for the future departure dates includes a yield average and a yield minimum for an associated departure date.

In some embodiments of the invention, the method further includes periodically obtaining additional future travel information associated with the travel provider, determining additional availability computation data based on the additional future travel information, determining whether at least a portion of the additional availability computation data exceeds an alert threshold, and updating the availability user interface with alert data in response to determining that at least the portion of the additional availability computation data exceeds the alert threshold.

In some embodiments of the invention, the availability user interface is configured to provide an alert mechanism in response to determining that the availability computation variation data for the provided time frame exceeds an alert threshold for one or more portions of the availability computation data.

In some embodiments of the invention, the one or more attributes includes a plurality of booking classes, wherein the availability computation data for the future departure dates includes a particular intervention input strategy.

In some embodiments of the invention, determining the availability computation variation data for the provided time frame includes determining that the particular intervention input strategy causes an event to occur in the availability computation variation data for an available booking class of the plurality of booking classes.

In some embodiments of the invention, determining the availability computation variation data for the provided time frame includes determining a lowest available price class available for the travel provider.

In some embodiments of the invention, determining the lowest available price class available for the travel provider includes identifying variation events associated with the availability computation variation data.

In some embodiments of the invention, the method further includes updating the availability user interface with variation monitoring data in response to identifying the variation events associated with the potential availability computation data.

In some embodiments of the invention, a device including a non-transitory computer-readable storage medium, and one or more processors coupled to the non-transitory computer-readable storage medium, wherein the non-transitory computer-readable storage medium includes program instructions that, when executed by the one or more processors, cause the one or more processors to perform the method as described above.

In some embodiments of the invention, a computing apparatus including one or more processors, at least one memory device coupled with the one or more processors, and a data communications interface operably associated with the one or more processors, where the memory device contains a plurality of program instructions that, when executed by the one or more processors, cause the computing apparatus to perform the method as described above.

In some embodiments of the invention, a non-transitory computer storage medium encoded with a computer program is provided, where the computer program includes a plurality of program instructions that when executed by one or more processors cause the one or more processors to perform the method as described above.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an environment for implementing a process for identifying a user using behavior data without using PII data, according to embodiments of the invention.

FIG. 2 illustrates an example of determining user matching results based on an availability request, according to embodiments of the invention.

FIG. 3 illustrates an example of availabilities for an airline based on a booking class, according to embodiments of the invention.

FIGS. 4-6 illustrate example screenshots for optimization of availability determination processes via an availability user interface, according to embodiments of the invention.

FIG. 7 is a flowchart of an example process for optimization of determining availabilities, according to embodiments of the invention.

FIG. 8 is a block diagram showing an example computer architecture for a computer capable of executing the software components described herein, according to embodiments described herein.

### DETAILED DESCRIPTION

The technology in this patent application is related to systems and methods for implementing an optimization of determining travel availabilities, specifically for airlines (e.g., the airline revenue management principle: “Sell the right seats to the right customers at the right prices and the right time”). More specifically, this technology includes a process that shows to the analyst the contribution on the final availability of the different products in order to identify quickly any anomalies and solve them by adjusting the faulting process. For example, the optimization is based on a decision support tool, e.g., a user interface (UI) that shows what effect pricing strategies (from revenue management, dynamic pricing, and intervention input) are having on available price ranges (e.g., booking classes) that are made available to end users for each departure date. An alert can be sent to the airline when a change in available booking class is logged that is over a specific threshold.

In the background, monitoring may be done on what availability is proposed to end users and what pricing strategies have driven changes in that availability. For example, an intervention input strategy may cause a large jump in an available booking class so that only expensive booking classes are shown as available to end users for the whole of the second semester of the year in question. The airline thus risks losing bookings (assuming end users tend to look for the lowest price) and should adjust or cancel a particular intervention input strategy. Furthermore, monitoring different intervention input strategies may provide a visualization for the end user, and demonstrate to the airlines that they may be ignoring advice from their revenue management system. This invention seeks to identify intervention input rules that are causing downstream problems and flag them (or override them, potentially) by monitoring the lowest available price class for a specific airline (can limit to a specific market) and looking for variations (e.g., jumps, peaks, troughs, etc.) in price and determining whether those variations are intended.

More specifically, this technology includes a process the provides daily computations of availability for all the network and may determine a lowest class available (LCA) for both weight associated with the LCA and the average LCA, and determine data used to compute availability such as dynamic pricing, intervention input, and revenue management system (RMS) data. The process may include iteratively (e.g., hourly, daily, etc.) sending availability requests for a particular airline for a set of origins and destination (O&D), information point of sales (PoS) data, and departure date data (DepDate). The process further includes determining, via an availability determination algorithm, a class proposed to a traveller, its yield (e.g., price without taxes), and capture data used for booking class availability computations such as dynamic pricing, intervention input, RMS data, and the like. The process further includes aggregating availability computation data, such as LCA weight average per O&D/PoS/DepDate, Yield average, LCA minimum, Yield minimum, and the like. The process further includes detecting variation in the class/yield proposed to a traveller. For example, monitoring for alert triggers, e.g., when a change in available booking class is logged that is over a specific threshold. The process further includes providing the availability computation data via a graphical user interface (GUI). For example, an LCA evolution user interface can allow a client to compare today's data versus yesterday data. Additionally, an alert system UI may be utilized by a client to visualize what may be driving availability, such as demand, competition, manual rules, and the like.

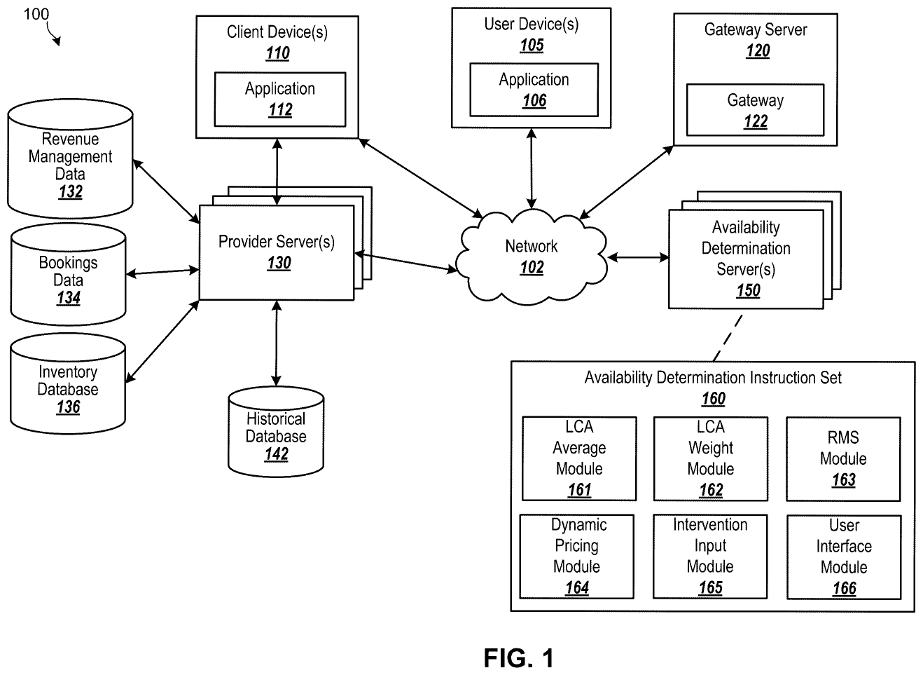

FIG. 1 is an example environment 100 for implementing a process for optimization of determining availabilities, according to embodiments of the invention. The example environment 100 includes a client device 110, a user device 105, a gateway server 120, one or more provider server(s) 130, and one or more availability determination server(s) 150, that communicate over a data communication network 102, e.g., a local area network (LAN), a wide area network (WAN), the Internet, a mobile network, or a combination thereof.

The user device 105 (e.g., an electronic device used by a user, such as a traveler booking a trip) and the client device 110 (e.g., an electronic device used by a requestor, such as an airline representative) can include a desktop, a laptop, a server, or a mobile device, such as a smartphone, tablet computer, wearable device (e.g., smartwatch), in-car computing device, and/or other types of mobile devices. The user device 105 includes applications, such as the application 106, for managing and booking a travel request with the one or more merchants associated with the one or more travel provider server(s) 130 (e.g., airlines, hotel, rental car, etc.). The client device 110 includes applications, such as the application 112, for managing an availability request and matching availability results to/from the one or more availability determination server(s) 150 via the gateway server 120. The client device 110 can include other applications. The client device 110 (e.g., a travel merchant) initiates an availability request by a requestor via application 112. An availability request may include availability computation data for future departure dates by requesting entities (such as clients, applications, browsers installed on user terminals, etc.) in the course of a request (e.g., an airline future availability determination request). A requestor of an availability request with a client device 110 via a provider server 130 may include any travel provider such as an airline or any other entity that may have similar availability needs.

The gateway 122 of the gateway server 120 manages the location of booking requests received from an application from the one or more user devices (e.g., a traveler's device) and availability requests received from application 112 from the one or more client devices 110. The management protocols of the gateway server 120 may be based on a redundant load-balancing system by managing multiple clients (e.g., client device(s) 110) so that an availability request is handled by one of the one or more availability determination server(s) 150. For example, there may be multiple availability determination server(s) 150 that are able to service the availability request, and the redundant load-balancing system of the gateway server 120 is responsible for ensuring that the availability request is performed by one of the capable availability determination server(s) 150.

The gateway server 120 may be a front-end server for managing, collecting, processing, and communicating availability queries (e.g., availability request), resource information, revenues management data, bookings data, airlines/system configurations data, etc., that is stored in the historical database 142 from the one or more provider server(s) 130 or one or more search engine server(s). Further, the gateway server 120 may be front end server for managing, collecting, processing, and communicating matching results from one or more availability determination server(s) 150 to the client devices 110 via application 112. In an exemplary embodiment, for an airline booking example, the gateway server 120 may be a front end server for collecting, processing, and storing travel information (e.g., flight schedules, flight information such as such as departure and destination airport, airline, departure and return dates, fares, booking classes, passenger information, and the like) from a plurality of external travel systems (e.g., airport information systems, airline information systems, third-party intermediator systems, etc.) via the one or more provider server(s) 130 to access the collective historical database 142, and/or the one or more availability determination server(s) 150.

The one or more provider server(s) 130 receives and processes travel inventory data such as revenue data stored in a revenues management database 132 from one or more revenue management system(s), bookings data stored in a bookings database 134 from one or more bookings management system(s), airlines/system inventory data from an inventory database 136 from one or more airlines/system configurations management system(s), and the like as real-time market data. The one or more provider server(s) 130 stores the travel inventory data from the multiple sources (e.g., revenues management database 132, bookings database 134, inventory database 136, etc.) in the historical database 142 for historical market data (e.g., availability data from a previous assessment of availabilities such as from the previous day).

The one or more availability determination server(s) 150 receives and processes, via the availability determination instruction set 160, the availability request(s) from the gateway server 120. The availability determination instruction set 160 includes an LCA average module 161, an LCA weight module 162, an RMS module 163, a dynamic pricing module 164, and intervention input module 165, and a user interface module 166.

The LCA weight module 162 may be utilized to determine a weight for each LCA computed per travel solution/departure date and considering each module separately or together (e.g., RMS, dynamic pricing, user intervention, and the like). This weight depends on the class determined and more expensive is the class, higher it is. The LCA average module 161 may be utilized to determine an average LCA weight per departure date. The RMS module 163 may be utilized to determine revenue data associated with the booking class availability computation. The dynamic pricing module 164 may be utilized for computing a target price by updating pricing based on the origin and destination information, departure dates, price levels through availability for current and past shopping dates. The intervention input module 165 may be utilized for obtaining the entered price data from the travel provider (e.g., pricing data associated with an intervention input strategy). The user interface module 166 may be utilized for generating and managing an availabilities user interface (e.g., a front-end API such as a “availabilities page”) at a client device (e.g., a travel provider server, such as an airline server).

In an embodiment, the LCA weight module 162 may determine the average LCA weight per departure date using different flight paths each having a different LCA. In order to compute the average LCA weight per departure date, the booking class may be ordered by value (e.g., from the booking class providing the cheapest range of fares to the most expensive booking class). The value of the rank of each booking class may be used by the LCA average module 161 as a weight to compute the average LCA weight per departure date.

In an embodiment, the dynamic pricing module 164 may implement a process to compute a target price based at least in part upon competition prices. In embodiments, the dynamic pricing module 164 may use rules to establish a fixed amount difference (e.g., a positive price different like +10USD or a negative price difference like −5USD) between the target price and competition prices, or a proportional price difference (e.g., +10% or −5%) between the target price and competition prices. In embodiments, the dynamic pricing module 164 may match the target price to competition prices. In embodiments, the dynamic pricing module 164 use a Customer Choice Model (CCM) aiming at maximizing the expected revenue depending upon the purchase probability (e.g., determine from the CCM and the characteristics of the alternatives from the competitors) and the expected revenue from the seat (e.g., price minus taxes). Because of the target price, the availability may be changed by the dynamic pricing module 164 in order to propose a range of prices closer to the target price. The availability computed by the RMS module 163 includes the results of the demands versus the capacity. In an embodiment, the final availability of a particular flight path in the availability determination instruction set 160 may represent the results of the different input processes (i.e., the output from one or more of the modules 161-166) combined with a set of constraints relating to an order of priority.

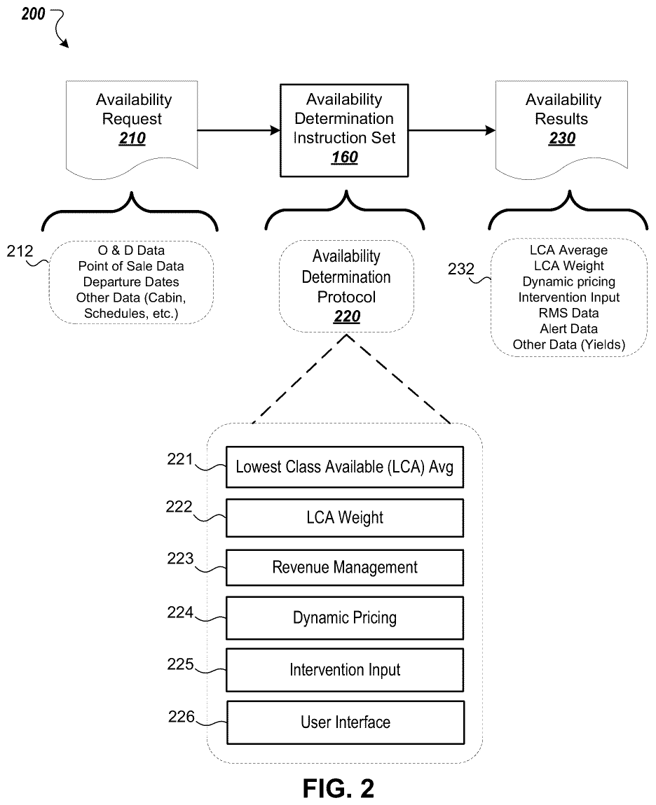

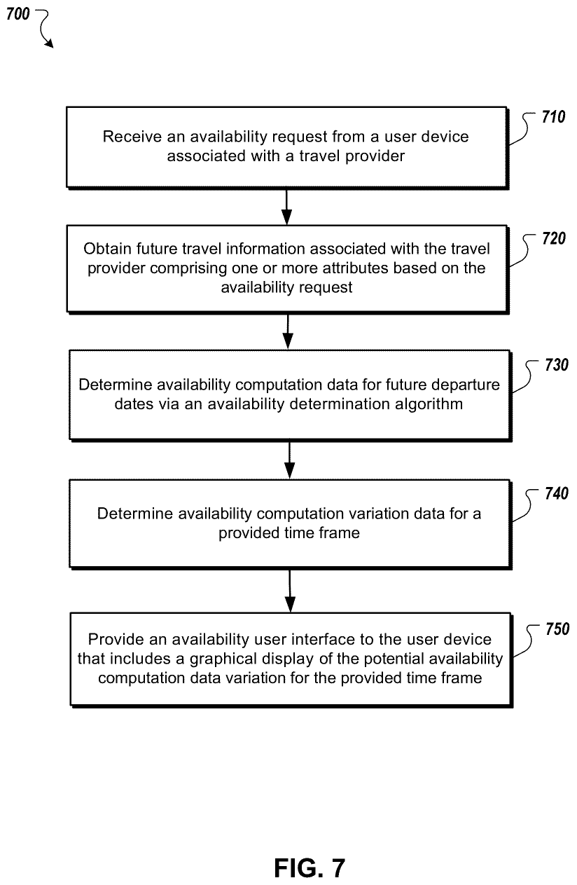

An example routine of implementing an optimization of determining availabilities as illustrated in the environment of FIG. 1 is further discussed herein with reference to the illustrations in FIGS. 2-6 and via the process flow diagram of FIG. 7.

FIG. 2 illustrates an example availability determination process based on an availability request, according to embodiments of the invention. In particular, FIG. 2 illustrates an example environment 200 for an availability determination implementation for determining availability results 230 based on receiving an availability request 210. The objective for the availability determination instruction set 160 is to implement an availability determination process (e.g., a prepare payment service that includes a complex orchestration aspect on front-end side to be able to call the services in the right order and at the right time of the payment flow) utilizing one or more payment orchestration servers that are in communication with the travel providers, travel reservation systems, and payment processors via a payment platform gateway. For example, the availability determination instruction set 160, stored on one or more availability determination server(s) 150, receives an availability request 210 (e.g., from a user device 105 or a client device 110). The availability request 210 includes availability request information 212 (e.g., O&D information, point of sale data, departure dates, other data such as cabin information and schedules, and the like) that is associated with determining availabilities for a travel provider (e.g., an airline).

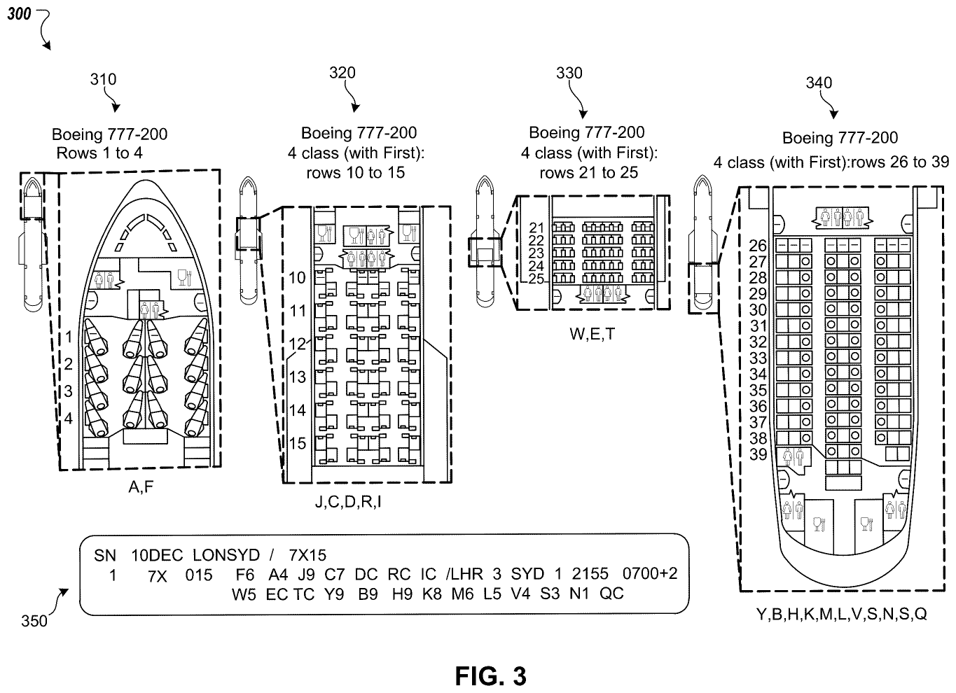

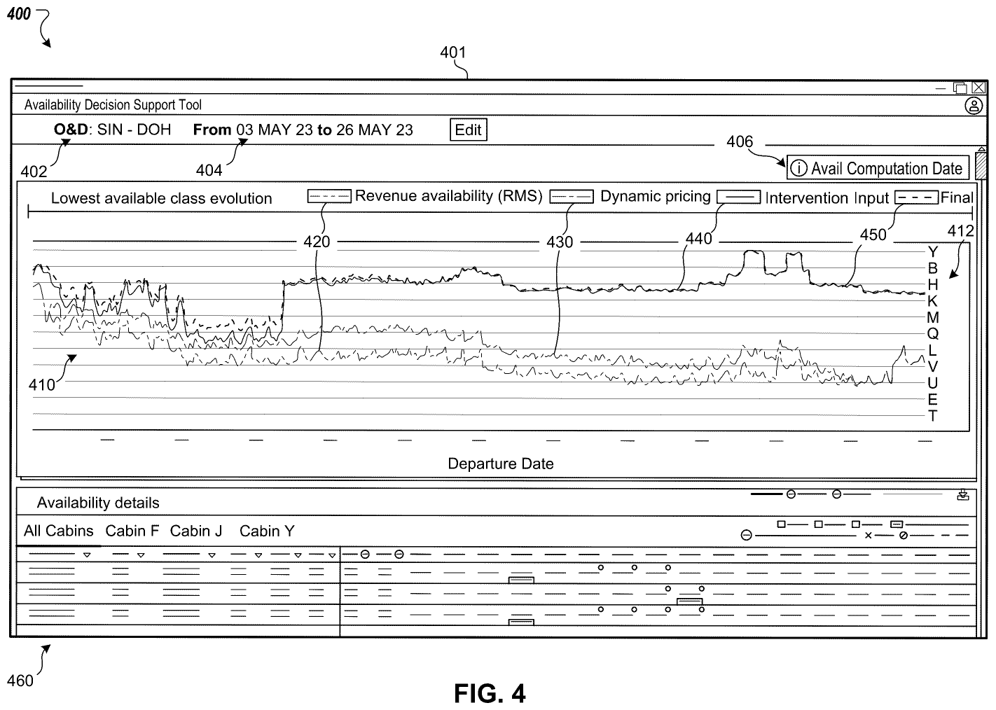

The availability determination instruction set 160 initiates an availability determination protocol 220 to generate availability results 230. The availability determination protocol 220 includes, for example, one or more modules to perform a plurality of services. The LCA weight module determines a weight for each LCA used for the booking class availability computation. The LCA average module determines an average LCA weight per departure date. The revenue management module provides revenue data associated with the booking class availability computation. The dynamic pricing module determines updated pricing based on the origin and destination information, departure dates, price levels through availability for current and past shopping dates. The intervention input module manages intervention feedback data received from a user. The user interface module is configured to provide, update, and manage, the availability user interface to the user. The availability results 230 may include availability determination results data 232 such as LCA average and weighted results, dynamic pricing data, the intervention input data, RMS data, alert data, and other valuation data such as yield information. An example illustration of implementing an availability determination protocol as illustrated in FIG. 2 is further discussed herein with reference to the illustrations in FIG. 3, the screenshots in FIGS. 4-6, and via the process flow diagram of FIG. 7.

FIG. 3 illustrates an example 300 of availabilities for an airline based on a booking class, according to embodiments of the invention. To optimize revenue, airlines define different category of price per cabin via the concept of booking classes such that airlines want to match booking class opened/closed continuously with the offer to the demanded forecast (e.g., “Sell the right seats to the right customers at the right prices and the right time”). For example, for a particular event (e.g., flight) to determine availability information, a particular piece of equipment may be used (e.g., an airplane, such as a Boeing 777-200 as illustrated). Additionally, and specifically for airlines, various airplanes may use two or different booking classes (e.g., business class, first class, coach, etc.). Thus, each grouping of rows may include one more booking class. A first section 310 of the plane may include rows 1 thru 4 (e.g., classes A, F). A second section 320 of the plane may include five different classes between rows 10 thru 15 (e.g., classes J, C, D, R, I). A third section 330 of the plane (e.g., exit rows) may include three different classes between rows 21 thru 25 (e.g., classes W, E, T). A fourth section 340 of the plane may include eleven different classes between rows 26 thru 39 (e.g., classes Y, B, H, HK, M, L, V, S, N, and Q).

The availability data 350 includes whether or not there are available seats for the particular flight, and for which associated booking class. For example, “C” indicates that class is fully booked (e.g., “closed”), and a number indicates the number of available seats for that particular class (e.g., “N1” indicates there is one seat available for the class “N” seats).

FIG. 4 illustrates an example screenshot 400 for an availability determination processes via an availability user interface 401, according to embodiments of the invention. The example screenshot 400 illustrates an example lowest available class evolution graph of the availability computations (e.g., availability results 230). The availability user interface 401 may also be referred to herein as “Availability Decision Support Tool.”

As illustrated in FIG. 4, the data setup may include an entry for origin and destination (O&D) information (e.g., element 402) and date entry range to support a world-to-world forecast for the next 361 days (e.g., element 404). Additionally, a comparison link (e.g., element 406) may be selected to obtain different comparisons from other forecast availability results (e.g., compare today vs yesterday or any other data set).

The user interface element at area 410 of the availability user interface 401 provides the different graphical results for the availability computations to illustrate the lowest available class evolutions for a provider. For example, the revenue availability results (e.g., graph line 420) provides a graphical representation of the revenue availability results. The dynamic pricing results (e.g., graph line 430) provides a graphical representation of the dynamic pricing results of the availability computations. The intervention input results (e.g., graph line 440) provides a graphical representation of the intervention input results of the availability computations. The final results (e.g., graph line 450) provides a graphical representation of the final results of the availability computations.

The user interface element at area 412 of the availability user interface 401 provides a list of the available classifications a user may select for the graphical evaluation data to be displayed. The user interface element at area 460 of the availability user interface 401 provides the detailed data impact for each booking class. For example, user interface element at area 460 provides the user with options to view a breakdown of the availability computation data for determining availability impacted by intervention(s) for a selected particular class.

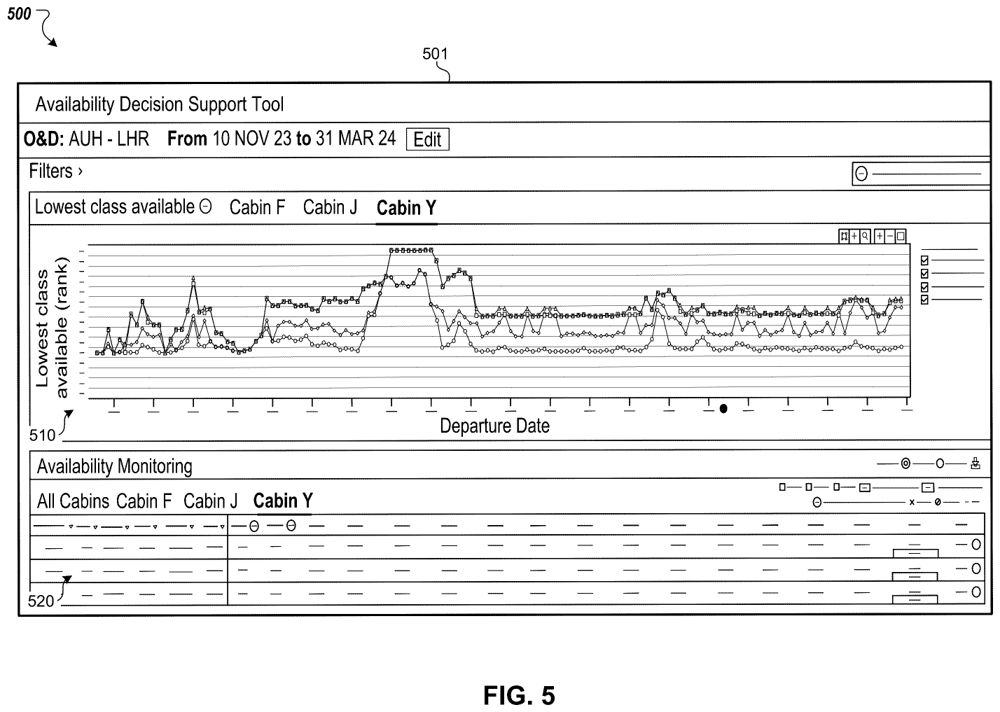

FIG. 5 illustrates an example screenshot 500 for an availability determination processes via an availability user interface 501, according to embodiments of the invention. The example screenshot 500 illustrates a particular cabin class evaluation result data (e.g., Cabin Y). For example, the user interface element at area 510 provides a graphical display for the availability computation data for the future departure dates (e.g., graphs for LCA average, a weight associated with the LCA, dynamic pricing, intervention input, and potential revenue data). User interface element at area 520 provides the user with options to view a breakdown of the availability computation data for determining availability impacted by intervention(s) for the particular class (e.g., classification cabin Y).

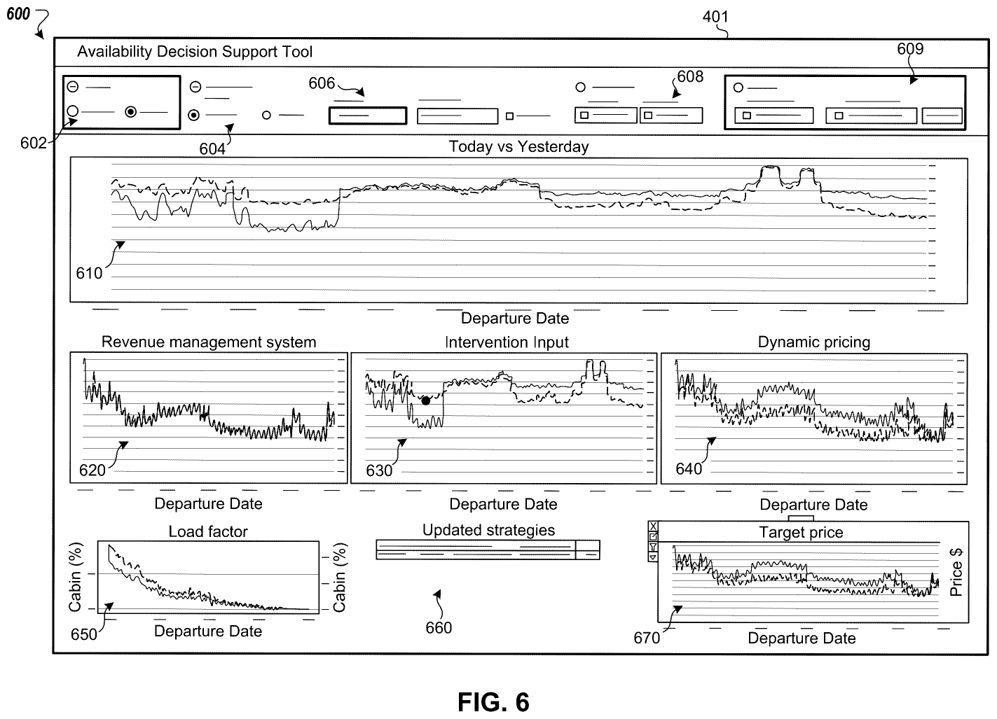

FIG. 6 illustrates an example screenshot 600 for an availability determination processes via an availability user interface 601, according to embodiments of the invention. The example screenshot 600 illustrates an alert screen for the availability computation data. As illustrated in FIG. 6, the data setup for the alert screen for the availability user interface 601 may include an entry for mode setup between a monitoring mode or a control mode (e.g., element 602), an entry for search methodology between base origin and destination (O&D) and crossed segment (e.g., element 604), an entry for O&D information (e.g., element 606), and an date entry range to support a world-to-world forecast for the next 361 days (e.g., element 608), and a sale date entry to search for particular sale reference data (e.g., element 609). Additionally, a comparison link (e.g., element 406) may be selected to obtain different comparisons from other forecast availability results (e.g., compare today vs yesterday or any other data set).

Additionally, the availability user interface 601 (e.g., an alert screen for the availability computation data), provides a graphical display for several different comparison graphs. For example, the user interface element at area 610 provides a graphical display for the availability computation data for comparing the LCA availability data for a comparison ran today vs a comparison of data ran a day before (e.g., graphs an LCA average calculated today compared to a calculation performed yesterday). User interface element at area 620 provides a graphical display for the availability computation data for the revenue management system results. User interface element at area 630 provides a graphical display for the availability computation data for the intervention input results. User interface element at area 640 provides a graphical display for the availability computation data for the dynamic pricing results. User interface element at area 650 provides a graphical display for the availability computation data for load factor data for comparing cabin classification data. User interface element at area 660 provides a list of different potential user inputs for entering different pricing strategies. User interface element at area 670 provides a graphical display for the availability computation data for the target price results.

FIG. 7 illustrates a flowchart of an example process 700 for optimization of determining availabilities, according to embodiments of the invention. Operations of the process 700 can be implemented, for example, by a system that includes one or more data processing apparatus, such as the one or more availability determination server(s) 150 of FIG. 1. The process 700 can also be implemented by instructions stored on computer storage medium (e.g., availability determination instruction set 160), where execution of the instructions by a system that includes a data processing apparatus causes the data processing apparatus to perform the operations of the process 700.

The system receives, at an availability determination server, an availability request from a user device associated with a travel provider (710). For example, the availability determination instruction set 160, stored on one or more availability determination server(s) 150 may receive an availability request from a requestor, such as an airline.

The system obtains, based on the availability request, future travel information associated with the travel provider, wherein the future travel information includes one or more attributes (720). For example, the availability determination instruction set 160, stored on one or more availability determination server(s) 150, obtains travel solution information, such as a class proposed to a customer, LCA and yield associated for a particular timeframe (e.g., next year). Additionally, the attributes may include the different booking classes available for a particular equipment (e.g., the model 777-200 as illustrated in FIG. 3).

In some embodiments of the invention, the one or more attributes include origin and destination information, departure dates, price levels through availability for current and past shopping dates, or a combination thereof. In some embodiments of the invention, the future travel information includes class information proposed to a user (e.g., a traveler) and yield information associated for a particular timeframe.

In some embodiments of the invention, the one or more attributes includes a plurality of booking classes, wherein the availability computation data for future departure dates includes a particular intervention input strategy. In some embodiments of the invention, determining the availability computation variation data for the provided time frame includes determining that the particular specific intervention input strategy causes an event (e.g., a large jump) to occur in the availability computation data variation for an available booking class of the plurality of booking classes.

The system determines, via an availability determination algorithm, availability computation data for future departure dates (730). For example, the availability determination instruction set 160, stored on one or more availability determination server(s) 150 may determine LCA average, LCA weight, dynamic pricing, intervention input, RMS data, etc. as discussed herein.

In some embodiments of the invention, determining the availability computation data for the future departure dates includes determining a lowest class available (LCA) average, a weight associated with the LCA, dynamic pricing, intervention input, potential revenue data, or a combination thereof. In some embodiments of the invention, the availability computation data for the future departure dates includes a yield average and a yield minimum for an associated departure date.

The system determines availability computation variation data for a provided time frame (740). For example, the system may monitor for alert triggers, i.e., when a change in available booking class is logged that is over a specific threshold. Additionally, the system may monitor the lowest available price class for a specific airline and looking for variations (e.g., jumps, peaks, troughs, etc.) in price and determining whether those variations are intended.

The system provides an availability user interface to the user device that includes a graphical display of the availability computation variation data for the provided time frame (750). For example, the system may display available price ranges (e.g., booking classes), provide the LCA evolution UI to compare today vs yesterday, provide an alert system UI to spot what is driving availability such as demand, competition, manual rules, etc. For example, as illustrated in screenshot 400 of FIG. 4, an end user may be provided with illustrations of several different graphs for the lowest available class evolution (over a year).

In some embodiments of the invention, the process 700 further includes periodically obtaining additional future travel information associated with the travel provider, determining additional availability computation data based on the additional future travel information, determining whether at least a portion of the additional availability computation data exceeds an alert threshold, updating the availability user interface with alert data in response to determining that at least a portion of the additional availability computation data exceeds the alert threshold. For example, when a change in available booking class is logged that is over a specific threshold.

In some embodiments of the invention, the availability user interface is configured to provide an alert mechanism in response to determining that the availability computation variation data for the provided time frame exceeds a threshold for one or more portions of the availability computation data. For example, availability determination system may provide an alert system UI to spot what is driving availability such as demand, competition, manual rules, and the like.

In some embodiments of the invention, determining the potential availability computation data for the provided time frame includes determining a lowest available price class available for the travel provider. For example, the availability system may monitor the lowest available price class for a specific airline (can limit to a specific market) and looking for variations (e.g., jumps, peaks, troughs, etc.) in price and determining whether those variations are intended. In some embodiments of the invention, determining the lowest available price class available for the travel provider includes identifying variation events associated with the potential availability computation data. For example, the availability system may identify jumps, peaks, troughs, etc. in price. In some embodiments of the invention, the process 700 may further include updating the availability user interface with variation monitoring data in response to identifying the variation events associated with the potential availability computation data.

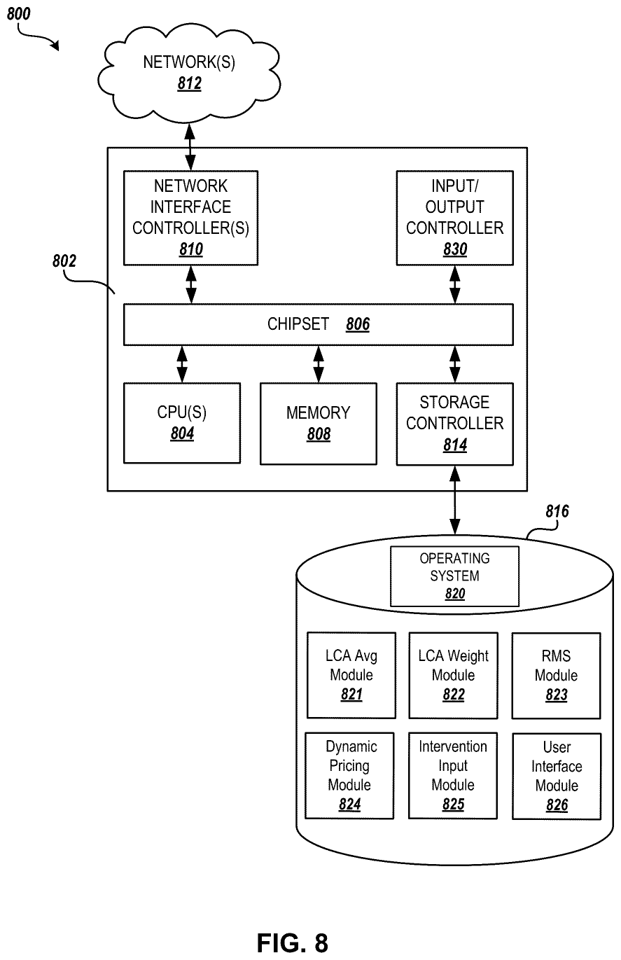

FIG. 8 illustrates an example computer architecture 800 for a computer 802 capable of executing the software components described herein for the sending/receiving and processing of tasks for the CA components. The computer architecture 800 (also referred to herein as a “server”) shown in FIG. 8 illustrates a server computer, workstation, desktop computer, laptop, or other computing device, and was utilized to execute any aspects of the software components presented herein described as executing on a host server, or other computing platform. The computer 802 preferably includes a baseboard, or “motherboard,” which is a printed circuit board to which a multitude of components or devices was connected by way of a communication bus or other electrical communication paths. In one illustrative embodiment, one or more central processing units (CPUs) 804 operate in conjunction with a chipset 806. The CPUs 804 can be programmable processors that perform arithmetic and logical operations necessary for the operation of the computer 802.

The CPUs 804 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements was combined to create more complex logic circuits, including registers, adders-subtractors, arithmetic logic units, floating-point units, or the like.

The chipset 806 provides an interface between the CPUs 804 and the remainder of the components and devices on the baseboard. The chipset 806 may provide an interface to a memory 808. The memory 808 may include a random-access memory (RAM) used as the main memory in the computer 802. The memory 808 may further include a computer-readable storage medium such as a read-only memory (ROM) or non-volatile RAM (NVRAM) for storing basic routines that that help to startup the computer 802 and to transfer information between the various components and devices. The ROM or NVRAM may also store other software components necessary for the operation of the computer 802 in accordance with the embodiments described herein.

According to various embodiments, the computer 802 may operate in a networked environment using logical connections to remote computing devices through one or more networks 812, a local-area network (LAN), a wide-area network (WAN), the Internet, or any other networking topology known in the art that connects the computer 802 to the devices and other remote computers. The chipset 806 includes functionality for providing network connectivity through one or more network interface controllers (NICs) 810, such as a gigabit Ethernet adapter. For example, the NIC 810 may be capable of connecting the computer 802 to other computer devices in the utility provider's systems. It should be appreciated that any number of NICs 810 may be present in the computer 802, connecting the computer to other types of networks and remote computer systems beyond those described herein.

The computer 802 may be connected to at least one mass storage device 818 that provides non-volatile storage for the computer 802. The mass storage device 818 may store system programs, application programs, other program modules, and data, which are described in greater detail herein. The mass storage device 818 may be connected to the computer 802 through a storage controller 814 connected to the chipset 806. The mass storage device 818 may consist of one or more physical storage units. The storage controller 814 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 802 may store data on the mass storage device 818 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 818 is characterized as primary or secondary storage, or the like. For example, the computer 802 may store information to the mass storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 802 may further read information from the mass storage device 818 by detecting the physical states or characteristics of one or more particular locations within the physical storage units.

The mass storage device 818 may store an operating system 820 utilized to control the operation of the computer 802. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 818 may store other system or application programs and data utilized by the computer 802, such as an LCA average module 821 (e.g., LCA average model 161), a LCA weight module 822 (e.g., LCA weight model 162), an RMS module 823 (e.g., RMS model 163), a dynamic pricing module 824 (e.g., dynamic pricing model 164), an intervention input module 825 (e.g., intervention input model 165), and a user interface module 826 (e.g., user interface model 166), according to embodiments described herein.

In some embodiments, the mass storage device 818 may be encoded with computer-executable instructions that, when loaded into the computer 802, transforms the computer 802 from being a general-purpose computing system into a special-purpose computer capable of implementing the embodiments described herein. These computer-executable instructions transform the computer 802 by specifying how the CPUs 804 transition between states, as described above. According to some embodiments, from the availability determination server(s) 150 perspective, the mass storage device 818 stores computer-executable instructions that, when executed by the computer 802, perform portions of the process 700, for implementing an optimization of determining availabilities process, as described herein. In further embodiments, the computer 802 may have access to other computer-readable storage medium in addition to or as an alternative to the mass storage device 818.

The computer 802 may also include an input/output controller 830 for receiving and processing input from a number of input devices, such as a keyboard, a mouse, a touchpad, a touch screen, an electronic stylus, or other type of input device. Similarly, the input/output controller 830 may provide output to a display device, such as a computer monitor, a flat-panel display, a digital projector, a printer, a plotter, or other type of output device. It will be appreciated that the computer 802 may not include all of the components shown in FIG. 8, may include other components that are not explicitly shown in FIG. 8, or may utilize an architecture completely different than that shown in FIG. 8.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A computer-implemented method comprising:
receiving, at an availability determination server, an availability request from a user device associated with a travel provider;
obtaining, based on the availability request, future travel information associated with the travel provider, wherein the future travel information comprises one or more attributes;
determining, via an availability determination algorithm, availability computation data for future departure dates;
determining availability computation variation data for a provided time frame; and
providing an availability user interface to the user device, the availability user interface comprising a graphical display of the availability computation variation data for the provided time frame.

2. The computer-implemented method of claim 1, wherein the one or more attributes comprise origin and destination information, departure dates, price levels through availability for current and past shopping dates, or a combination thereof.

3. The computer-implemented method of claim 1, wherein the future travel information comprises class information proposed to a user and yield information associated for a particular timeframe.

4. The computer-implemented method of claim 1, wherein determining the availability computation data for the future departure dates comprises:
determining a lowest class available (LCA) average, a weight associated with the LCA, dynamic pricing, intervention input, potential revenue data, or a combination thereof.

5. The computer-implemented method of claim 1, wherein the availability computation data for the future departure dates comprises a yield average and a yield minimum for an associated departure date.

6. The computer-implemented method of claim 1, further comprising:
periodically obtaining additional future travel information associated with the travel provider;
determining additional availability computation data based on the additional future travel information;
determining whether at least a portion of the additional availability computation data exceeds an alert threshold; and
updating the availability user interface with alert data in response to determining that at least the portion of the additional availability computation data exceeds the alert threshold.

7. The computer-implemented method of claim 1, wherein the availability user interface is configured to provide an alert mechanism in response to determining that the availability computation variation data for the provided time frame exceeds an alert threshold for one or more portions of the availability computation data.

8. The computer-implemented method of claim 1, wherein the one or more attributes comprises a plurality of booking classes, wherein the availability computation data for the future departure dates comprises a particular intervention input strategy.

9. The computer-implemented method of claim 8, wherein determining the availability computation variation data for the provided time frame comprises:
determining that the particular intervention input strategy causes an event to occur in the availability computation variation data for an available booking class of the plurality of booking classes.

10. The computer-implemented method of claim 1, wherein determining the availability computation variation data for the provided time frame comprises:
determining a lowest available price class available for the travel provider.

11. The computer-implemented method of claim 10, wherein determining the lowest available price class available for the travel provider comprises:
identifying variation events associated with the availability computation variation data.

12. The computer-implemented method of claim 11, further comprising:
updating the availability user interface with variation monitoring data in response to identifying the variation events associated with the potential availability computation data.

13. A computing apparatus comprising:
one or more processors; and
at least one memory device coupled with the one or more processors,
wherein the at least one memory device contains a plurality of program instructions that, when executed by the one or more processors, cause the one or more processors to execute operations comprising:
receiving, at an availability determination server, an availability request from a user device associated with a travel provider;
obtaining, based on the availability request, future travel information associated with the travel provider, wherein the future travel information comprises one or more attributes;
determining, via an availability determination algorithm, availability computation data for future departure dates;
determining availability computation variation data for a provided time frame; and
providing an availability user interface to the user device, the availability user interface comprising a graphical display of the availability computation variation data for the provided time frame.

14. The computing apparatus of claim 13, wherein the one or more attributes comprise origin and destination information, departure dates, price levels through availability for current and past shopping dates, or a combination thereof.

15. The computing apparatus of claim 13, wherein the future travel information comprises class information proposed to a user and yield information associated for a particular timeframe.

16. The computing apparatus of claim 13, wherein determining the availability computation data for the future departure dates comprises:
determining a lowest class available (LCA) average, a weight associated with the LCA, dynamic pricing, intervention input, potential revenue data, or a combination thereof.

17. The computing apparatus of claim 13, wherein the availability computation data for the future departure dates comprises a yield average and a yield minimum for an associated departure date.

18. The computing apparatus of claim 13, wherein the at least one memory device contains a plurality of program instructions that, when executed by the one or more processors, further cause the one or more processors to execute operations comprising:
periodically obtaining additional future travel information associated with the travel provider;
determining additional availability computation data based on the additional future travel information;
determining whether at least a portion of the additional availability computation data exceeds an alert threshold; and
updating the availability user interface with alert data in response to determining that at least a portion of the additional availability computation data exceeds the alert threshold.

19. The computing apparatus of claim 13, wherein the availability user interface is configured to provide an alert mechanism in response to determining that the availability computation variation data for the provided time frame exceeds a threshold for one or more portions of the availability computation data.

20. A non-transitory computer storage medium encoded with a computer program, the computer program comprising a plurality of program instructions that, when executed by one or more processors, cause the one or more processors to perform operations comprising:
receiving, at an availability determination server, an availability request from a user device associated with a travel provider;
obtaining, based on the availability request, future travel information associated with the travel provider, wherein the future travel information comprises one or more attributes;
determining, via an availability determination algorithm, availability computation data for future departure dates;
determining availability computation variation data for a provided time frame; and
providing an availability user interface to the user device, the availability user interface comprising a graphical display of the availability computation variation data for the provided time frame.
